(19) United States
(12) Patent Application Publication
(10) Pub. No.: US 2005/0282994 A1
(43) Pub. Date: Dec. 22, 2005

(54) N-alkyl melamine formaldehyde crosslinking and curable compositions

(76) Inventors: John C. Brogan, Greenwich, CT (US); Lawrence A. Flood, Norwalk, CT (US); Urvee Y. Treasurer, Stamford, CT (US)

Correspondence Address: CYTEC INDUSTRIES INC., 1937 WEST MAIN STREET, P.O. BOX 60, STAMFORD, CT, 06904-0060, US

(21) Appl. No.: 10/871,808

(22) Filed: Jun. 18, 2004

(51) Int. Cl. C08G 12/30

(52) U.S. Cl. 528/258

(57) ABSTRACT

This invention relates to bis-N-alkyl melamine formaldehyde crosslinking composition or a blend of bis- and tris-N-alkyl melamine formaldehyde crosslinking composition. This invention also contemplates curable compositions comprising the bis-N-alkyl melamine formaldehyde composition and an active hydrogen-containing material and a curable composition comprising the blend of bis- and tris-N-alkyl melamine formaldehyde compounds and an active hydrogen-containing material.

### FIELD OF THE INVENTION

The invention is directed to crosslinking compositions. In particular, the invention relates to bis-N-alkyl melamine formaldehyde compositions and a mixture of bis- and tris-N-alkyl melamine formaldehyde compositions.

### BACKGROUND OF THE INVENTION

Traditional industrial coatings have for years been based in significant part on backbone resins having active hydrogen groups crosslinked with various derivatives of amino-1,3,5-triazines. Most notable among the amino-1,3,5-triazine derivatives are the aminoplasts such as the alkoxymethyl derivatives of melamine and guanamines which, while providing excellent results in a number of aspects, have the disadvantage of not providing high quality, high gloss films at low temperature cures. High temperature crosslinking systems require more energy to cure and/or crosslink slower resulting in less throughput. In addition, further effort has been expended to develop crosslinkers with lower viscosity at a given solids content to reduce volatile organic compound (VOC) emissions. As a result, it has long been a desire of industry to find acceptable alternative crosslinkers and coatings systems, which cure at lower temperatures, yield lower VOCs and provide high quality, high gloss films.

South African Patent Application 721933 discloses the use of tris-alkyl melamine formaldehyde crosslinking agents with a water dispersible hydroxy-functional acrylic polymer for electrode positing a film on metal. However, the document neither discloses nor teaches the use of bis-alkyl melamine formaldehyde crosslinking agents or a mixture of bis- and tris-alkyl melamine formaldehyde crosslinking agents.

An article by Bright et al., entitled “Alkylmelamine Crosslinking Agent in High Solids Coating Systems” in Polymeric Material Science Engineering, (55 PMSEDG 1986, pgs. 229 to 234) discloses the use of bis-amylmelamine formaldehyde crosslinking agent and tris-methyl melamine formaldehyde crosslinking agents with hydroxy-functional acrylic and polyester polymers. The article notes that films containing these crosslinkers have poor humidity resistance. The document neither discloses nor teaches using bis-C₁-C₄ alkyl melamine formaldehyde crosslinking agents or a mixture of bis- and tris-alkyl melamine formaldehyde crosslinking agents.

### SUMMARY OF THE INVENTION

This invention relates to bis-alkyl melamine formaldehyde crosslinking composition or a mixture of bis- and tris-alkyl melamine formaldehyde crosslinking composition. The bis-alkyl melamine formaldehyde composition is comprised of compounds having the structure of Formula I: 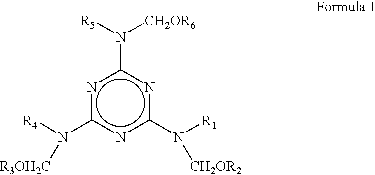
wherein R₁ is hydrogen or CH₂OR₇, R₄ and R₅ are each independently an alkyl of 1 to about 4 carbon atoms, an aryl of about 6 to about 24 carbon atoms or aralkyl of about 7 to about 24 carbon atoms; R₂, R₃, R₆, and R₇ are each independently hydrogen, alkyl, aryl, aralkyl, alkoxyalkyl or an alkaryl having from 1 to about 24 carbon atoms.

Another embodiment of this invention is a composition comprising a mixture of bis- and tris-alkyl melamine formaldehyde compounds having the structure of Formula I above wherein R₄ and R₅ are each independently an alkyl of 1 to about 18 carbon atoms, an aryl of about 6 to about 24 carbon atoms or aralkyl of about 7 to about 24 carbon atoms; R₂, R₃, R₆, and R₇ are each independently hydrogen, alkyl, aryl, aralkyl, alkoxyalkyl or an alkaryl having from 1 to about 24 carbon atoms; and for bis-alkyl melamine formaldehyde compounds, R₁ is hydrogen or CH₂OR₇, and for tris-alkyl melamine formaldehyde compounds, R . . . is an alkyl of 1 to about 18 carbon atoms, an aryl of about 6 to about 24 carbon atoms or aralkyl of about 7 to about 24 carbon atoms. This invention also contemplates curable compositions comprising the bis-alkyl melamine crosslinking composition and an active hydrogen-containing material and a curable composition comprising the mixture of bis- and tris-alkyl melamine formaldehyde compounds and an active hydrogen-containing material.

### DETAILED DESCRIPTION OF THE INVENTION

The term “and/or” means either or both. For example, “A and/or B” means A or B, or both A and B.

In this invention the term “resin” and “polymer” are used interchangeably.

This invention relates to a composition comprising compounds having the structure of Formula I: 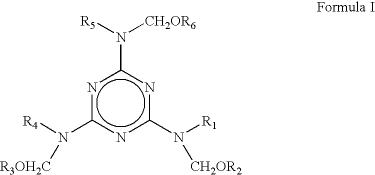
wherein R₁ is hydrogen or CH₂OR₇, R₄ and R₅ are each independently an alkyl of 1 to about 4 carbon atoms, an aryl of about 6 to about 24 carbon atoms or aralkyl of about 7 to about 24 carbon atoms; R₂, R₃, R₆, and R₇ are each independently hydrogen, alkyl, aryl, aralkyl, alkoxyalkyl or an alkaryl having from 1 to about 24 carbon atoms. Preferably, R₂ to R₇ are each independently an alkyl of 1 to 4 carbon atoms or methyl and/or butyl.

Another embodiment of this invention is a composition comprising a mixture of bis- and tris-alkyl melamine formaldehyde compounds having the structure of Formula I above wherein R₄ and R₅ are each independently an alkyl of 1 to about 18 carbon atoms, an aryl of about 6 to about 24 carbon atoms or aralkyl of about 7 to about 24 carbon atoms; R₂, R₃, R₆, and R₇ are each independently hydrogen, alkyl, aryl, aralkyl, alkoxyalkyl or an alkaryl having from 1 to about 24 carbon atoms; and for bis-alkyl melamine formaldehyde compounds, R₁ is hydrogen or CH₂OR₇; and for tris-alkyl melamine formaldehyde compounds, R₁ is an alkyl of 1 to about 18 carbon atoms, an aryl of about 6 to about 24 carbon atoms or aralkyl of about 7 to about 24 carbon atoms. Preferably, R₁ to R₆ are each independently a C₁ to C₄ alkyl for the tris-alkyl melamine and R₂ to R₇ are each independently a C₁ to C₄ alkyl for the bis-alkyl melamine. More preferably, R₁ to R₆ are each independently methyl and/or butyl for the tris-alkyl melamine formaldehyde compound and R₂ to R₇ are each independently methyl and/or butyl for the bis-alkyl melamine formaldehyde compound.

The ratio of bis-alkyl melamine formaldehyde compounds to tris-alkyl melamine formaldehyde compounds in the mixture may range from a high of about 500:1 or about 100:1 or about 10:1 or about 4:1 or about 2:1 to a low of about 1:2 or about 1:4, or about 1:10 or about 1:100 or about 1:500.

The above crosslinking compounds of Formula I may be prepared by the procedure outlined in the aforementioned paper by Bright et al., herein incorporated by reference. The above bis- and tris-alkyl melamine formaldehyde compounds may be prepared by first preparing a bis- or tris-alkyl melamine. These alkyl melamines can be made from cyanuric chloride as known in prior art appearing in ‘Substituted Chlorodiamino-s-triazines’, Pearlman et. al., Journal of American Chemical Society, Vol. 70, pages 3726-28, 1948; and ‘Cyanuric Chloride Derivatives II Substituted Melamines’, Kaiser et. al., Journal of American Chemical Society, Vol. 73, pages 2984-86, 1951; both herein incorporated by reference. Thus, the alkylmelamines may be produced by reacting cyanuric chloride with a monoalkylamine in a suitable solvent at temperatures ranging from −5° C. to 50° C. for 0.5 to 15 hours. The resulting intermediate may be reacted with additional monoalkylamine and/or ammonia at temperatures ranging from 50° C. to 120° C. for 0.5 to 24 hours to produce the bis- or tris-alkyl melamines or a mixture of the two. A mixture in the desired bis/tris ratio can be obtained by using a suitable molar ratio of the monoalkylamine and ammonia in the reaction. Alternatively the bis/tris alkyl melamines can also be made by reacting melamine with alkylamine at a higher temperature in presence of catalyst (acid, ammonium chloride, para toluene sulfonic acid, etc.), preferably under pressure or by the high temperature reaction of melamine with alkylamine hydrochloride. These reactions of melamine are referenced in Heterocyclic Compounds s-Triazine and Derivatives, Smolin and Rapoport, Chapter VI, 1959 and in Japanese Patent Publication JP 2003012654, herein incorporated by reference. The alkyl melamines may then be reacted with excess formaldehyde (methylolation step) under acid or basic conditions at temperatures ranging from 20° C. to 70° C. for 0.1 to 5 hours. The methylolated product is then etherified with an alcohol under acidic conditions at temperatures ranging from 20° C. to 50° C. for 0.1 to 10 hours. The methylolation and etherification steps may be repeated to get the desired levels of methylolation and etherification. The resulting crosslinker is then isolated and filtered to achieve the final product.

The mixture of bis- and tris-alkyl melamine formaldehyde compounds may also be prepared by simply admixing the composition containing the two compounds.

Non-limiting examples of monoalkylamines that may be used in the reaction are monomethylamine, monoethylamine, monopropylamine, monoisopropylamine, monobutylamine, monoisobutylamine, monoethylhexylamine and phenylamine.

Non-limiting examples of alcohols that may be used in the etherification step are methanol, ethanol, propanol, isopropanol, butanol, isobutanol, cyclohexanol, phenol, benzyl alcohol, monoalkyl ether of ethylene or propylene glycol and mixtures thereof.

The methylolation step is preferably conducted in the presence of a catalyst. An acid or base catalyst may be used. Non-limiting examples of acid catalysts are: p-toluenesulfonic acid, sulfamic acid, glacial acetic acid, mono or polychlorinated acetic acids, sulfuric acid, nitric acid, napthylenesulfonic acid, alkyl phosphonic acids, phosphoric acid and formic acid. Non-limiting examples of base catalysts are inorganic basic salts such as the hydroxides, carbonates or bicarbonates of lithium, sodium, potassium, calcium and magnesium, or the organic bases and basic salts such as amines and guanidine, quaternary-ammonium, phosphonium hydroxide and (bi-)carbonate salts.

The etherification reaction is preferably conducted in the presence of an acid catalyst. The same acid catalysts described above for the methylolation reaction may also be used in the etherification reaction.

In the preparation of the compounds of Formula I, oligomeric products resulting from a self-condensation reaction may be obtained. Non-limiting examples of these self-condensation products are given in Formulas II and III below. 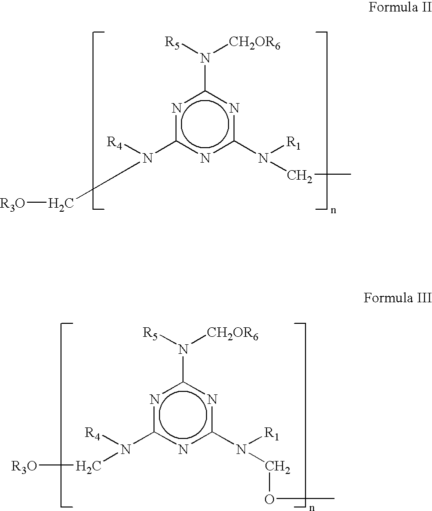
wherein R₁ to R₆ are defined above for the bis-alkyl melamine formaldehyde composition and for the bis/tris-alkyl melamine formaldehyde mixture.

This invention also contemplates curable compositions comprising the bis-alkyl melamine formaldehyde composition and an active hydrogen-containing material and a curable composition comprising the mixture of bis- and tris-alkyl melamine formaldehyde compounds and an active hydrogen-containing material.

The active hydrogen-containing resins of the present invention contain functionalities reactive with the alkyl melamine formaldehyde compounds such as hydroxy, carboxy, carbamato, amino, amido, mercapto, or a blocked functionality which is convertible to any of the preceding reactive functionalities. These active hydrogen-containing materials are those which are conventionally used in a minoresin coatings, and in general are considered well-known to those of ordinary skill in the relevant art.

Suitable active hydrogen-containing materials include, for example, polyfunctional hydroxy group containing materials such as polyols, hydroxy-functional acrylic resins having pendant or terminal hydroxy functionalities, hydroxy-functional polyester resins having pendant or terminal hydroxy functionalities, hydroxy-functional urethane and carbamate resins having pendant or terminal hydroxy functionalities; products derived from the condensation of epoxy compounds with an amine, and mixtures thereof. Acrylic and polyester resins are preferred. Examples of the polyfunctional hydroxy group containing materials include DURAMACD 203-1385 alkyd resin (Eastman Chemical Co); BECKSOL® 12-035 Coconut Oil Alkyd (Reichhold Chemical Co., Durham, N.C.); JONCRYL° 500 and 1540 acrylic resin (Johnson Polymers, Racine, Wis.); AT400 acrylic resin (Rohm & Haas, Philadelphia, Pa.); CYPLEX® polyester resin (Cytec Industries, West Paterson, N.J.); CARGILL® 3000 and 5776 polyester resins (Cargill, Minneapolis, Minn.); TONE® polyester resin (Union Carbide, Danbury, Conn.); K-FLEX® XM-2302 and XM-2306 resins (King Industries, Norwalk, Conn.); CHEMPOL® 11-1369 resin (Cook Composites and Polymers (Port Washington, Wis.); CRYLCOAT® 3494 solid hydroxy terminated polyester resin (UCB CHEMICALS USA, Smyrna, Ga.); RUCOTE® 101 polyester resin (Ruco Polymer, Hicksville, N.Y.); JONCRYL® SCX-800-A and SCX-800-B hydroxy-functional solid acrylic resins (Johnson Polymers, Racine, Wis.); and the like.

Examples of carboxyfunctional resins include CRYLCOAT® solid carboxy terminated polyester resin (UCB CHEMICALS USA, Smyrna, Ga.). Suitable resins containing amino, amido, carbamato or mercapto groups, including groups convertible thereto, are in general well-known to those of ordinary skill in the art and may be prepared by known methods including copolymerizing a suitably functionalized monomer with a comonomer capable of copolymerizing therewith.

The amount of these active hydrogen-containing materials that may be added should be such that the weight ratio of the active hydrogen-containing material to the alkyl melamine formaldehyde compounds (dry weight basis) is in the range of from about 99:1 to about 0.5:1 or about 10:1 to about 0.8:1 or about 4:1 to about 0.8:1.

The curable compositions of the present invention may optionally further comprise a cure catalyst. The cure catalysts usable in the present invention include sulfonic acids, aryl, alkyl, and aralkyl sulfonic acids; aryl, alkyl, and aralkyl phosphoric and phosphonic acids; aryl, alkyl, and aralkyl acid pyrophosphates; carboxylic acids; sulfonimides; mineral acids and mixtures thereof. Of the above acids, sulfonic acids are preferred when a catalyst is utilized. Examples of the sulfonic acids include benzenesulfonic acid, para-toluenesulfonic acid, dodecylbenzenesulfonic acid, dinonylnaphthalenedisulfonic acid, and a mixture thereof. Examples of the aryl, alkyl, and aralkyl phosphates and pyrophosphates include phenyl, para-tolyl, methyl ethyl, benzyl, diphenyl, di-para-tolyl, di-methyl, di-ethyl, di-benzyl, phenyl-para-tolyl, methyl-ethyl, phenyl-benzyl phosphates and pyrophosphates. Examples of the carboxylic acids include benzoic acid, formic acid, acetic acid, propionic acid, butyric acid, dicarboxylic acids such as oxalic acid, fluorinated acids such as trifluoroacetic acid, and the like. Examples of the sulfonimides include dibenzene sulfonimide, di-para-toluene sulfonimide, methyl-para-toluene sulfonimide, dimethyl sulfonimide, and the like. Examples of the mineral acids include nitric acid, sulfuric acid, phosphoric acid, poly-phosphoric acid, and the like. All of the above acid catalysts may be blocked with an amine. Non-limiting examples of such amines are dimethyl oxazolidine, 2-amino-2-methyl-1-propanol, n,n-dimethylethanolamine or combinations thereof.

The weight percent of the cure catalyst, if present, is in the range of from about 0.01 to about 5.0 wt % based on the weight of the alkyl melamine formaldehyde compounds and active hydrogen-containing resins (dry weight basis).

The curable composition may also contain other optional ingredients such as fillers, light stabilizers, pigments, flow control agents, plasticizers, mold release agents, corrosion inhibitors, and the like. It may also contain, as an optional ingredient, a medium such as a liquid medium to aid the uniform application and transport of the curable composition. Any or all of the ingredients of the curable composition may be contacted with the liquid medium. Particularly preferred is a liquid medium, which is a solvent for the curable composition ingredients. Suitable solvents include aromatic hydrocarbons, aliphatic hydrocarbons, halogenated hydrocarbons, ketones, esters, ethers, amides, alcohols, water, compounds having a plurality of functional groups such as those having an ether and an ester group, and mixtures thereof.

The present curable compositions may employ a liquid medium such as a solvent, or it may employ solid ingredients as in powder coatings, which typically contain no liquids. Contacting may be carried out by dipping, spraying, padding, brushing, rollercoating, flowcoating, curtaincoating, electrocoating or electrostatic spraying.

The liquid or powder coating compositions and a substrate to be coated are contacted by applying the curable composition onto the substrate by a suitable method, for example, by spraying in the case of the liquid compositions and by electrostatic spraying in the case of the powder compositions. In the case of powder coatings, the substrate covered with the powder composition is heated to at least the fusion temperature of the curable composition forcing it to melt and flow out and form a uniform coating on the substrate. It is thereafter fully cured by further application of heat, typically at a temperature in the range of about 120° C. to about 220° C. for a period of time in the in the range of about 5 minutes to about 30 minutes and preferably for a period of time in the range of 10 to 20 minutes.

In the case of the liquid compositions, the solvent is allowed to partially evaporate to produce a uniform coating on the substrate. Thereafter, the coated substrate is allowed to cure at temperatures of about 20° C. to about 150° C., or about 25° C. to about 120° C. for a period of time in the in the range of about 20 seconds to about 30 days depending on the temperature used to obtain a cured film. In a particularly advantageous embodiment curable compositions of the present invention can be heat cured at lower temperatures preferably ranging from about 20° C. to about 120° C. or about 70° C. to about 110° C.

Another embodiment of this invention is a waterborne curable compositions comprising the curable compositions described above and water. The waterborne curable composition may permit formation of a dispersion, emulsion, invert emulsion, or solution of the ingredients of the curable composition. The waterborne curable composition may optionally contain a surfactant, an emulsification agent, a dispersant or mixtures thereof.

The amount of total solids present in the waterborne curable composition is about 1 to about 60 wt. %, or about 10 to about 55 wt. % or about 25 to about 50 wt. %, based on the total weight of the composition.

The weight ratio of active hydrogen-containing material to crosslinker of Formula I (dry weight basis) present in the waterborne curable composition is about 99:1 to about 1:1 or 95:5 to about 60:40 or about 90:10 to about 70:30.

The amount of surfactant present in the waterborne curable composition is about 0 to about 10 wt. %, or about 0.1 to about 5 wt. % or about 0.5 to about 2.0 wt. %, based on the weight of the total active hydrogen-containing material in the composition.

The solvent components in the waterborne curable composition are solvents such as water and an optional co-solvent. Examples of such optional co-solvents are solvents listed above. Preferred co-solvents for the waterborne composition are alcohols and glycol ethers. The amount of co-solvent that may be used is from 0 to about 30 wt. % or about 2 to about 25 wt. % or about 5 to about 15 wt. %, based on the total weight of the active hydrogen-containing material and crosslinker of Formula I (dry weight basis) in the waterborne curable composition.

Surfactants, emulsification agents and/or dispersants are molecules, which have a hydrophobic portion (A) and a hydrophilic portion (B). They may have the structure A-B, A-B-A, B-A-B, etc. Typically, the hydrophobic section can be an alkyl, an alkaryl, a polypropylene oxide block, a polydimethylsiloxane block or a fluorocarbon. The hydrophilic block of a non-ionic surfactant is a water soluble block, typically a polyethylene oxide block or a hydroxylated polymer block. The hydrophilic block of an anionic surfactant is typically an acid group ionized with a base. Typical acid groups are carboxylic acids, sulfonic acids or phosphoric acids. Typical bases used to ionize the acids are NaOH, KOH, NH₄OH and a variety of tertiary amines, such as triethyl amine, triisopropyl amine, dimethyl ethanol amine, methyl diethanol amine and the like.

The anionic surfactants that may be used include, for example, a fatty acid salt, a higher alcohol sulfuric acid ester, an alkylbenzene sulfonate, an alkyl naphthalene sulfonate, a naphthalene sulfonic acid-formarin condensation product, a dialkyl sulfone succinate, an alkyl phosphate, a polyoxyethylenesulfate and an anion composed of a special polymer active agent. Particularly preferred are, for example, a fatty acid salt such as potassium oleate and a higher alcohol sulfuric acid ester salt such as sodium lauryl sulfate. The cationic surfactants include, for example, an alkylamine salt, a quaternary ammonium salt and a polyoxyethylene alkylamine. Particularly preferred is a quaternary ammonium salt such as lauryl trimethyl ammonium chloride or cetyltrimethyl ammonium chloride. Amphoteric surfactants include alkylbetaines such as laurylbetaine and stearylbetaine. The non-ionic surfactants include, for example, a polyoxyethylenealkyl ether, a polyoxyethylene alkylphenol ether, a sorbitane fatty acid ester, a polyoxyethylene sorbitane fatty acid ester, a polyoxyethylene acryl ester, an oxyethylene-oxypropylene block polymer and a fatty acid monoglyceride.

Preferred active hydrogen containing-materials useful for waterborne curable compositions are hydroxyfunctional acrylic resins such as Joncryl® 1540.

The curable compositions of this invention may be employed as coatings in the general areas of coatings such as original equipment manufacturing (OEM) including automotive coatings, general industrial coatings including industrial maintenance coatings, architectural coatings, agricultural and construction equipment coatings (ACE), powder coatings, coil coatings, can coatings, wood coatings, and low temperature cure automotive refinish coatings. They are usable as coatings for wire, appliances, automotive parts, furniture, pipes, machinery, and the like. Suitable surfaces include metals such as steel and aluminum, plastics, wood, and glass.

The curable compositions of the present invention are particularly well suited to coat heat sensitive substrates such as plastics and wood which may be altered or destroyed entirely at the elevated cure temperatures prevalent in the heat curable compositions of the prior art.

The invention described and claimed herein is not to be limited in scope by the specific embodiments herein disclosed, since these embodiments are intended as illustrations of several aspects of the invention. Any equivalent embodiments are intended to be within the scope of this invention. Indeed, various modifications of the invention in addition to those shown and described herein will become apparent to those skilled in the art from the foregoing description. Such modifications are also intended to fall within the scope of the appended claims.

### EXAMPLES

### Example 1

### Preparation of Bis-alkylmelamine Formaldehyde Crosslinking Agent Tetramethoxymethyl Bismethylmelamine (QMMBMM)

N,N′-bismethylmelamine was prepared using the following ingredients.

TABLE 1
Ingredients for N,N-bismethylmelamine

| Ingredients | Weight in grams |
|---|---|
| Cyanuric chloride | 140.00 |
| Acetonitrile | 580.00 |
| 40% aqueous methylamine | 59.00 |
| 25% aqueous caustic | 121.60 |
| 29.5% aqueous ammonium hydroxide | 97.00 |
| 40% aqueous methylamine | 118.00 |
| 25% aqueous caustic | 61.00 |

A suitable reactor equipped with nitrogen sparge, mechanical agitation, temperature control, including heating and cooling, and water condenser was used for this preparation. Thus, 0.76 mole of cyanuric chloride was charged to the reactor and dissolved in acetonitrile and cooled to −5 to +5° C. One molar equivalent of 40% aqueous methylamine was added slowly, followed by neutralization with one mole equivalent NaOH. The resulting mono-N-methyl dichloro triazine was reacted with two molar equivalent of aqueous ammonia at temperature ranging from 25 to 40° C. The third chloro group was reacted with two molar equivalent of 40% aqueous methyl amine at reflux temperature. A solid product was formed, which was treated with xylene, washed with water and dried under vacuum to yield pure bis methylmelamine in 65 to 70% yield.

A suitable reactor equipped with nitrogen sparge, mechanical agitation, temperature control, water condenser and vacuum distillation set up was used for the preparation of the tetramethoxymethyl bismethylmelamine crosslinker. Thus, 0.5 mole of N,N′-bis-methyl melamine prepared above was methylolated with methyl formcel, 3.0 mole equivalent of formaldehyde, under alkaline conditions (pH 10.0 to 11.0) at 45° C. for 25 minutes, followed by alkylation with 10.0 mole equivalent methanol under acidic conditions (pH 2.5 to 3.0, temperature 35 to 40° C.) and stripped, under reduced pressure, following neutralization to pH 10 to 11. A second methylolation with 1.5 mole equivalent formaldehyde and alkylation with 10.0 mole equivalent methanol (pH 2.0 to 2.5, 35° C., 25 minutes) was carried out followed by neutralization to basic pH and stripping, under reduced pressure, for product concentration. 150 grams of clear crosslinking agent at 98 to 100% foil solids and Gardner Holt viscosity in range of Z to Z₄ was obtained.

### Example 1C

### Preparation of N-alkylmelamine Formaldehyde Crosslinkinq Agent Trismethoxymethyl Trimethylmelamine (TMMTMM)

A suitable reactor equipped with nitrogen sparge, mechanical agitation, temperature control, water condenser and vacuum distillation set up was used for this preparation. Thus, 2.5 mole of N, N′, N″-trimethyl melamine was methylolated with methyl formcel, 4.5 mole equivalent of formaldehyde, under alkaline conditions (pH 10.0 to 11.0) at 45° C. for 25 minutes, followed by alkylation with 10.0 mole equivalent methanol under acidic conditions (pH 2.5 to 3.0, temperature 35 to 40° C.) and stripped, under reduced pressure, following neutralization to pH 10 to 11. A second methylolation with 1.5 mole equivalent formaldehyde and alkylation with 10.0 mole equivalent methanol (pH 2.0 to 2.5, 35° C., 25 minutes) was carried out followed by neutralization to basic pH and stripping, under reduced pressure for product concentration. The resulting product obtained upon filtration was 600 grams of clear crosslinking agent at 98 to 100% foil solids and Gardner Holt viscosity in range of V to Y.

### Examples 2 and 2C

### Preparation of Coating Compositions

The coating compositions were prepared by mixing the following ingredients.

TABLE 2
Ingredients for Coating Composition

| | |
|---|---|
| Joncryl ® 500 acrylic polymer (80% solids) | 87.5 g |
| Crosslinking Agent of Examples 1 and 1C | 30.0 g |
| Cycat ® 600 Catalyst | 1.43 g |
| AMP-95 (2-amino-2-methyl-1-propanol) | 0.35 g |
| Methanol | 8.22 g |
| Xylene | 7.2 g |
| Propylene Glycol Monomethyl Ether Acetate | 5.0 g |
| Dynoadd ® F-100 Flow Control Additive | 0.5 g |
| Cyasorb ® UV-1164L light absorber | 3.1 |
| Sanduvor ® 3058 HALS | 1.0 |
| Total | 144.3 g |

### Examples 3 and 3C

### Preparation of Films

Films were prepared by applying a few grams of the coating composition of Examples 2 and 2C to the top of a 4″×12″ primed steel panel and using a wire-wound cator to drawdown the applied formulation resulting in a uniform film. The coated panel is then allowed to flash at room temperature for about 10 minutes and then placed in an oven for 30 minutes at the desired cure temperatures.

### Example 4

### Film Hardness and MEK Resistance Properties

Film hardness (KHN₂₅) and MEK Resistance at various cure temperatures were measured 14 days after bake (23° C., 3% RH) and shown below.

TABLE 3
Film Hardness (KHN₂₅)

| | Example 3 | Example 3C |
|---|---|---|
| Cure Temp ° C. | QMMBMM | TMMTMM |
| 90 | 6.7 | 9 |
| 100 | 9.7 | 11.1 |
| 110 | 10.9 | 11.8 |

TABLE 3A
MEK Resistance

| | Example 3 | Example 3C |
|---|---|---|
| Cure Temp ° C. | QMMBMM | TMMTMM |
| 90 | 175/200+ | 200+/200+ |
| 100 | 200+/200+ | 200+/200+ |
| 110 | 200+/200+ | 200+/200+ |

Solvent Resistance is measured by methyl ethyl ketone (MEK) double rubs to mar (first number) and remove (2^{nd} number) the coatings. Highly crosslinked coatings require 200+ (i.e., more than 200) rubs to mar.

### Example 5

### Cleveland Humidity Resistance

Cleveland Humidity resistance testing as performed by ASTM D 4585 (Testing Water Resistance of Coatings using Controlled Condensation) was measured for films prepared with compositions in Examples 3 and 3C at 38(C and 60(C temperatures. These are shown below in Tables 4 and 5 at various cure temperatures.

TABLE 4
Cleveland Humidity at 38° C. using 90° C., 100° C. and 110° C.
cure temperature (20° Gloss/Blister rating)

| Time | Example 3 | Example 3C | Example 3 | Example 3C | Example 3 | Example 3C |
|---|---|---|---|---|---|---|
| (hrs) | 90° C. Cure | 90° C. Cure | 100° C. Cure | 100° C. Cure | 110° C. Cure | 110° C. Cure |
| 0 | 97.5/10 | 98.2/10 | 98.5/10 | 99/10 | 99/10 | 100.4/10 |
| 24 | 9F | 9F | 9F | 9F | 9F | 9F |
| 72 | 96.9/9F | 87.7/9D | 96.9/9F | 99.5/9M | 97.7/9F | 99.4/9M |
| 240 | 93.2/9M | 78.4/9D | 97.5/9F | 88.0/9D | 98.4/9F | 95.6/9M |

Blister Rating - ASTM D 714 Standard Test Method for Evaluating Degree of Blistering of Paints
Gloss - ASTM D 523 Standard Test Method for Specular Gloss

TABLE 5
Cleveland Humidity at 60° C. using 90° C., 100° C. and 110° C.
cure temperature (20° Gloss/Blister rating)

| Time | Example 3 | Example 3C | Example 3 | Example 3C | Example 3 | Example 3C |
|---|---|---|---|---|---|---|
| (hrs) | 90° C. Cure | 90° C. Cure | 100° C. Cure | 100° C. Cure | 110° C. Cure | 110° C. Cure |
| 0 | 97.0/10 | 98.2/10 | 98.2/10 | 99.4/10 | 98.8/10 | 100.3/10 |
| 24 | 9M | 9D | 10 | 9D | 10 | 9D |
| 72 | 90.8/.8MD | 86.7/8D | 92.0/9M | 86.4/8D | 97.4/10 | 92.1/9D |
| 240 | 85.5/8MD | 64.1/8D | 92.0/9MD | 51.4/9D | 95.3/9M | 74.2/9D |

Legend for Blister Rating (Size & Frequency)

| Size | Description |
|---|---|
| 10 | No blisters |
| 9 | Microblisters |
| 8 | Small blisters |
| 6 | Medium blisters |

| Frequency | Description |
|---|---|
| D | Dense |
| MD | Medium Dense |
| M | Medium |
| F | Few |

### Example 6

### Wet Adhesion Test

Subsequent to the humidity tests, the adhesion of the films were tested according to ASTM D3359 (Test Method A). The results are shown in Tables 6 below:

TABLE 6
Wet Adhesion Test after Cleveland Humidity test at 38° C. and 60° C.

| Cure Temp | Example 3 | Example 3C | Example 3 | Example 3C |
|---|---|---|---|---|
| ° C. | 38° C. | 38° C. | 60° C. | 60° C. |
| 90 | 0 | 1 | 5 | 5* |
| 100 | 5 | 0 | 4 | 5* |
| 110 | 5 | 0 | 0 | 5* |

*Films softened and lost integrity due to hydrolysis

Legend for Wet Adhesion Test

| Rating | Description |
|---|---|
| 5 | No peeling or removal |
| 4 | Trace peeling or removal along incisions or at their intersection |
| 3 | Jagged removal along incisions up to 1.6 mm on either side |
| 2 | Jagged removal along most of incisions up to 3.2 mm on |
| | either side |
| 1 | Removal from most of the area of the X under the tape |
| 0 | Removal beyond the area of the X |

### Example 7

### Film Hardness Properties After Cleveland Humidity Tests

Film hardness (KHN₂₅) at various cure temperatures was measured 1 day after the Cleveland Humidity tests. The results are shown in Table 7 below.

TABLE 7
Film Hardness (KHN₂₅) Percent Retained after Cleveland Humidity test at
38° C. and 60° C.

| Cure Temp | Example 3 | Example 3C | Example 3 | Example 3C |
|---|---|---|---|---|
| ° C. | 38° C. | 38° C. | 60° C. | 60° C. |
| 90 | 87% | 92% | 54% | 40% |
| 100 | 96% | 88% | 68% | 31% |
| 110 | 101% | 83% | 80% | 38% |

### Example 8

### MEK Solvent Resistance After Cleveland Humidity Tests

MEK solvent resistance at various cure temperatures was measured 1 day after the Cleveland Humidity tests. The results are shown in Table 8 below.

TABLE 8
MEK Solvent Resistance after Cleveland Humidity test
at 38° C. and 60° C.

| Cure Temp | Example 3 | Example 3C | Example 3 | Example 3C |
|---|---|---|---|---|
| ° C. | 38° C. | 38° C. | 60° C. | 60° C. |
| 90 | 50/75* | 125/150 | 25/75 | 1/25 |
| 100 | 150/200 | 175/200+ | 25/75 | 1/25 |
| 110 | 200+/200+ | 200+/200+ | 75/100 | 1/25 |

*Failed due to loss of Adhesion to substrate

### Example 9

### Preparation of Mixture of Bis- and Tris-alkylmelamine

Preparation of bis/tris-butylmelamine from melamine and alkyl amine was done using the following ingredients and the procedure outlined below.

TABLE 9
Ingredients for production of bis/tris butylmelamine

| Ingredients | Weight in grams |
|---|---|
| Melamine | 20.3 |
| Butylamine | 48.4 |
| p-toluene sulfonic acid | 3.2 |

A closed Hastelloy VSP (Vent Sizing Package) cell was charged with the above ingredients, heated to 220-235° C. and held for about 3 hours with stirring. Maximum pressure generated was 1000 psig. The ammonia was not vented. Conversion from melamine was in the range of 55-60%. Analysis of the product by LC-MS, after isolation by filtration and concentration to remove unreacted butylamine, indicated product mainly composed of bis and tris-butylmelamine and some mono species.

### Example 10

### Preparation of Mixture of Bis- and Tris-alkylmelamine Formaldehyde Crosslinking Agents Tetramethoxymethyl Bismethylmelamine and Trismethoxymethyl Trimethylmelamine (QMMBMM and TMMTMM))

A suitable reactor equipped with nitrogen sparge, mechanical agitation, temperature control, water condenser and vacuum distillation set up was used for this preparation. Thus, 1.0 mole of a mixture of mono- (5 parts), bis- (45 parts) and tris- (50 parts) methyl melamine was methylolated with methyl formcel, 4.5 mole equivalent of formaldehyde, under alkaline conditions (pH 10.0 to 11.0) at 45° C. for 25 minutes, followed by alkylation with 10.0 mole equivalent methanol under acidic conditions (pH 2.5 to 3.0, temperature 35 to 40° C.) and stripped, under reduced pressure, following neutralization to pH 10 to 11. A second methylolation with 1.5 mole equivalent formaldehyde and alkylation with 10.0 mole equivalent methanol (pH 2.0 to 2.5, 35° C., 25 minutes) was carried out followed by neutralization to basic pH and stripping, under reduced pressure, for product concentration. 200 grams of clear crosslinking agent at 98 to 100% foil solids and Gardner Holt viscosity in range of Z to Z₂ was obtained.

### Example 11

### Film Hardness Properties

A coating composition and films were produced using the crosslinking agent of Example 10 according to the procedures disclosed in Examples 2 and 3. These films were compared to films produced using the crosslinking agent of Example 3C also according to the procedure in Examples 2 and 3. Film hardness (KHN₂₅) at various cure temperatures was measured 3 days after bake.

TABLE 10
Film Hardness (KHN₂₅)

| | Example 11 | Example 3C |
|---|---|---|
| Cure Temp ° C. | QMMBMM/TMMTMM | TMMTMM |
| 90 | 6.5 | 7 |
| 100 | 8.8 | 9.4 |
| 110 | 10.2 | 10.3 |

### Example 12

### MEK Solvent Resistance After Cleveland Humidity Tests

MEK solvent resistance at various cure temperatures was measured 3 days after the Bake. The results are shown in Table 11 below.

TABLE 11
MEK Solvent Resistance

| Cure Temp | Example 11 | Example 3C |
|---|---|---|
| ° C. | QMMBMM/TMMTMM | TMMTMM |
| 90 | 125/200 SW | 125/200 SW |
| 100 | 200+ SW | 200+ |
| 110 | 200+ | 200+ |

Solvent Resistance is measured by methyl ethyl ketone (MEK) double rubs to mar (first number) and remove (2^{nd} number) the coatings. Highly crosslinked coatings require 200+ (i.e., more than 200) rubs to mar.
SW—coating swelled

### Example 13

### Cleveland Humidity Resistance

Cleveland Humidity resistance testing as performed by ASTM D 4585 was measured for the films prepared in Example 11 and compared with films prepared with the composition in Example 3C at 38° C. and 60° C. temperatures. These results are shown below in Tables 12 and 13 at various cure temperatures.

TABLE 12
Cleveland Humidity at 38° C. using 90° C., 100° C. and 110° C.
cure temperature (20° Gloss/Blister rating)

| Time | Example 11 | Example 3C | Example 11 | Example 3C | Example 11 | Example 3C |
|---|---|---|---|---|---|---|
| (hrs) | 90° C. Cure | 90° C. Cure | 100° C. Cure | 100° C. Cure | 110° C. Cure | 110° C. Cure |
| 0 | 96.7/10 | 98.0/10 | 96.9/10 | 97.4/10 | 98.0/10 | 98.1/10 |
| 16 | 10 | 10 | 10 | 10 | 10 | 10 |
| 40 | 10 | 10 | 10 | 10 | 10 | 10 |
| 240 | 8F | 8M | 10 | 8FM | 10 | 8F |
| 336 | 97.1/8F | 97.3/8M | 97.7/10 | 97.8/8MD | 97.9/10 | 97.2/8F |
| 528 | 97.3/8FM | 96.2/8M | 98.1/10 | 98.3/8MD | 98.7/10 | 98.9/8M |

TABLE 13
Cleveland Humidity at 60° C. using 90° C., 100° C. and 110° C.
cure temperature (20° Gloss/Blister rating)

| Time | Example 11 | Example 3C | Example 11 | Example 3C | Example 11 | Example 3C |
|---|---|---|---|---|---|---|
| (hrs) | 90° C. Cure | 90° C. Cure | 100° C. Cure | 100° C. Cure | 110° C. Cure | 110° C. Cure |
| 0 | 95.9/10 | 95.4/10 | 97.4/10 | 98.8/10 | 98.6/10 | 99.3/10 |
| 16 | 8F | 8M | 10 | 8MD | 10 | 8M |
| 40 | 8F | 8M | 10 | 8MD | 10 | 8M |
| 240 | 8FM± | 8M± | 10 | 8MD± | 10 | 8M± |
| 336 | 28.7/8FM± | 1.3/6D± | 79.4/8F± | 0.6/8D± | 89.2/10 | 60.2/8D± |

±Film whitened or hazy due to moisture pickup

### Example 14

### Waterborne Coating Composition

A clear film-forming water-borne coating composition is prepared by mixing together lowing ingredients:

TABLE 14
Ingredients for Waterborne Composition

| | Solid Weight | Solution weight |
|---|---|---|
| Ingredient | in grams | in grams |
| Joncryl ® 1540 Acrylic Emulsion | 87.0 | 204.7 |
| Cycat ® 600 Catalyst | 0.82 | 1.17 |
| 2-amino-2-methyl-1-propanol | | 0.47 |
| (95% in water) | | |
| n-butanol | | 1.64 |
| QMMBMM resin of Example 1 | 13.0 | 13.0 |
| and | | |
| QMMBMM/TMMTMM resin of | | |
| Example 10 | | |
| Dipropylene glycol monomethyl | | 8.2 |
| ether | | |
| Dipropylene glycol monobutyl | | 8.2 |
| ether | | |

Films are prepared by applying a few grams of the waterbone coating composition to the top of a 4″×12″ steel panel and using a wire-wound cator to drawdown the applied formulation resulting in a uniform film. The coated panel is then allowed to flash at room temperature for about 10 minutes and then is placed in an oven for 30 minutes at the desired cure temperatures.

The invention described and claimed herein is not to be limited in scope by the specific embodiments herein disclosed, since these embodiments are intended as illustrations of several aspects of the invention. Any equivalent embodiments are intended to be within the scope of this invention. Indeed, various modifications of the invention in addition to those shown and described herein will become apparent to those skilled in the art from the foregoing description. Such modifications are also intended to fall within the scope of the appended claims.

1. A composition comprising compounds having the structure of Formula I: 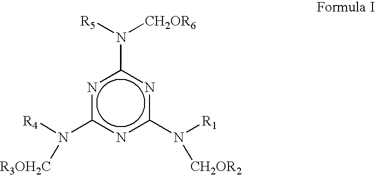
wherein R₁ is hydrogen or CH₂OR₇, R₄ and R₅ are each independently an alkyl of 1 to about 4 carbon atoms, an aryl of about 6 to about 24 carbon atoms or aralkyl of about 7 to about 24 carbon atoms; R₂, R₃, R₆ and R₇ are each independently hydrogen, alkyl, aryl, aralkyl, alkoxyalkyl or an alkaryl having from 1 to about 24 carbon atoms.

2. The composition of claim 1, wherein R₄ and R₅ are each independently a C₁ to C₄ alkyl.

3. The composition of claim 2, wherein R₂ to R₇ are each independently methyl and/or butyl.

4. A curable composition comprising:
(i) a composition comprising compounds having the structure of Formula I: 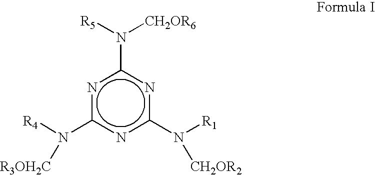
wherein R₁ is hydrogen or CH₂OR₇, R₄ and R₅ are each independently an alkyl of 1 to about 4 carbon atoms, an aryl of about 6 to about 24 carbon atoms or aralkyl of about 7 to about 24 carbon atoms; R₂, R₃, R₆ and R₇ are each independently hydrogen, alkyl, aryl, aralkyl, alkoxyalkyl or an alkaryl having from 1 to about 24 carbon atoms;
(ii) an active hydrogen-containing material; and
(iii) optionally water.

5. The curable composition of claim 4, wherein said active hydrogen containing material are resins containing functionalities selected from hydroxy, carboxy, carbamato, amino, amido, mercapto, a blocked functionality which is convertible to any of the preceding reactive functionalities and mixtures thereof.

6. The curable composition of claim 4, wherein said active hydrogen-containing resin is a polyfunctional hydroxy group containing materials selected from polyols, hydroxy-functional acrylic resins having pendant or terminal hydroxy functionalities, hydroxy-functional polyester resins having pendant or terminal hydroxy functionalities, hydroxy-functional urethane and/or carbamate resins having pendant or terminal hydroxy functionalities; products derived from the condensation of epoxy compounds with an amine, and mixtures thereof.

7. The curable composition of claim 5, further comprising a cure catalyst.

8. The curable composition of claim 7, wherein said cure catalyst is blocked by an amine.

9. The curable composition of claim 4, further comprising a solvent.

10. The curable composition of claim 4, further comprising water.

11. The curable composition of claim 10, further comprising a surfactant, an emulsification agent, and/or a dispersant.

12. A composition comprising a mixture of bis- and tris-alkyl melamine formaldehyde compounds having the structure of Formula I: 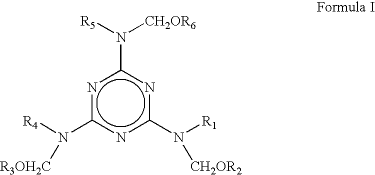
wherein R₄ and R₅ are each independently an alkyl of 1 to about 18 carbon atoms, an aryl of about 6 to about 24 carbon atoms or aralkyl of about 7 to about 24 carbon atoms; R₂, R₃, R₆ and R₇ are each independently hydrogen, alkyl, aryl, aralkyl, alkoxyalkyl or an alkaryl having from 1 to about 24 carbon atoms; and for bis-alkyl melamine formaldehyde compounds, R₁ is hydrogen or CH₂OR₇; and for tris-alkyl melamine formaldehyde compounds, R₁ is an alkyl of 1 to about 18 carbon atoms, an aryl of about 6 to about 24 carbon atoms or aralkyl of about 7 to about 24 carbon atoms.

13. The composition of claim 12, wherein R₁ to R₆ are each independently a C₁ to C₄ alkyl for the tris-alkyl melamine formaldehyde compounds and wherein R₂ to R₇ are each independently a C₁ to C₄ alkyl for the bis-alkyl melamine formaldehyde compounds.

14. The composition of claim 12, wherein R₁ to R₆ are each independently methyl and/or butyl for the tris-alkyl melamine formaldehyde compounds and wherein R₂ to R₇ are each independently methyl and/or butyl for the bis-alkyl melamine formaldehyde compounds.

15. A curable composition comprising
(i) a composition comprising a mixture of bis- and tris-alkyl melamine formaldehyde compounds having the structure of Formula I: 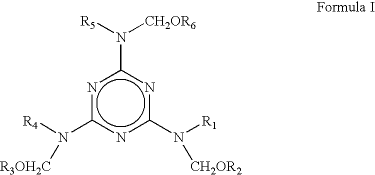
wherein R₄ and R₅ are each independently an alkyl of 1 to about 18 carbon atoms, an aryl of about 6 to about 24 carbon atoms or aralkyl of about 7 to about 24 carbon atoms; R₂, R₃, R₆ and R₇ are each independently hydrogen, alkyl, aryl, aralkyl, alkoxyalkyl or an alkaryl having from 1 to about 24 carbon atoms; and for bis-alkyl melamine formaldehyde compounds, R₁ is hydrogen or CH₂OR₇; and for tris-alkyl melamine formaldehyde compounds, R₁ is an alkyl of 1 to about 18 carbon atoms, an aryl of about 6 to about 24 carbon atoms or aralkyl of about 7 to about 24 carbon atoms;
(ii) an active hydrogen-containing material; and
(iii) optionally water.

16. The curable composition of claim 15, wherein said active hydrogen containing material are resins containing functionalities selected from hydroxy, carboxy, carbamato amino, amido, mercapto, a blocked functionality which is convertible to any of the preceding reactive functionalities and mixtures thereof.

17. The curable composition of claim 15, wherein said active hydrogen-containing resin is a polyfunctional hydroxy group containing materials selected from polyols, hydroxy-functional acrylic resins having pendant or terminal hydroxy functionalities, hydroxy-functional polyester resins having pendant or terminal hydroxy functionalities, hydroxy-functional urethane and/or carbamate resins having pendant or terminal hydroxy functionalities; products derived from the condensation of epoxy compounds with an amine, and mixtures thereof.

18. The curable composition of claim 15, further comprising a cure catalyst.

19. The curable composition of claim 18, wherein said cure catalyst is blocked by an amine.

20. The curable composition of claim 15, further comprising a solvent.

21. The curable composition of claim 15, further comprising water.

22. The curable composition of claim 21, further comprising a surfactant, an emulsification agent, and/or a dispersant.

23. A composition comprising compounds from Formula II and/or Formula III: 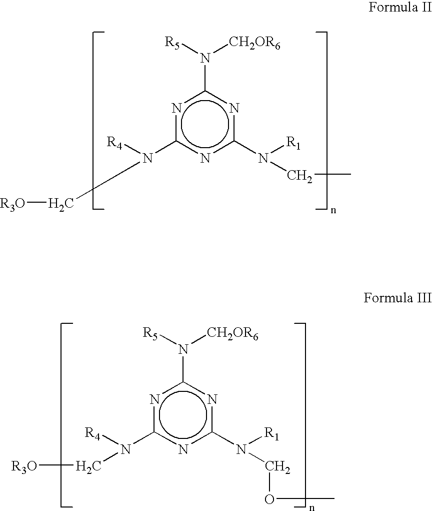
wherein n is 2 to 50; R₁ is hydrogen or CH₂OR₇; R₄ and R₅ are each independently an alkyl of 1 to about 18 carbon atoms, an aryl of about 6 to about 24 carbon atoms or aralkyl of about 7 to about 24 carbon atoms; R₂, R₃, R₆ and R₇ are each independently hydrogen or an alkyl having from 1 to about 4 carbon atoms.

24. A composition comprising a blend of bis- and tris-alkyl melamine formaldehyde compounds having the structure of Formula II and/or Formula III: 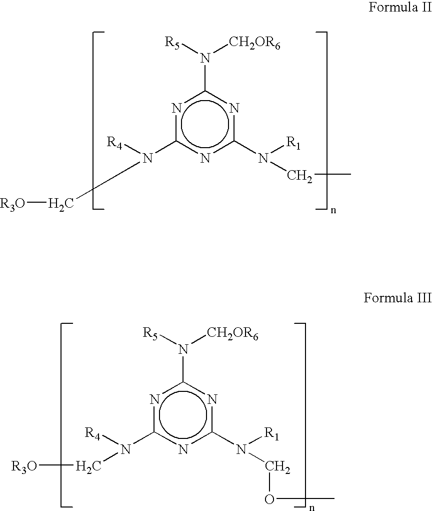
wherein R₄ and R₅ are each independently an alkyl of 1 to about 18 carbon atoms, an aryl of about 6 to about 24 carbon atoms or aralkyl of about 7 to about 24 carbon atoms; R₂, R₃, R₆ and R₇ are each independently hydrogen, alkyl, aryl, aralkyl, alkoxyalkyl or an alkaryl having from 1 to about 24 carbon atoms; and for bis-alkyl melamine formaldehyde compounds, R₁ is hydrogen or CH₂OR₇; and for tris-alkyl melamine formaldehyde compounds, R₁ is an alkyl of 1 to about 18 carbon atoms, an aryl of about 6 to about 24 carbon atoms or aralkyl of about 7 to about 24 carbon atoms.
